(19) United States
(12) Patent Application Publication
(10) Pub. No.: US 2013/0013517 A1
(43) Pub. Date: Jan. 10, 2013

(54) MAKING AN EXTENDED WARRANTY COVERAGE DECISION

(76) Inventors: Guillermo Gallego, Waldwick, NJ (US); Ruxian Wang, New York, NY (US); Julie Ward Drew, Redwood City, CA (US)

(21) Appl. No.: 13/178,072

(22) Filed: Jul. 7, 2011

(51) Int. Cl. G06Q 10/00

(52) U.S. Cl. 705/302

(57) ABSTRACT

Systems, methods, and machine-readable and executable instructions are provided for making an extended warranty coverage. Making an extended warranty decision can include determining by a computer, a customer's expected cost of terminating the extended warranty coverage, determining, by the computer, the customer's expected cost of continuing the extended warranty coverage, and comparing, by the computer, the expected cost of terminating the extended warranty coverage and the expected cost of continuing the extended warranty coverage. Making an extended warranty decision can also include determining, by the computer, the extended warranty coverage decision based on the comparison.

### BACKGROUND

Hardware trends in industries with rapid technological innovation, such as personal computing, adversely impact the sales of extended warranties. Declines in personal computer prices make replacing a personal computer a viable alternative to paying for repairs of buying an extended warranty. Flexible duration support services can appeal to a broader range of customers than fixed duration services. In particular, duration flexibility can attract customers who are uncertain about a base product's reliability but will buy warranty coverage while they observe product failures, or lack thereof, and update their prior beliefs about the product liability. Warranty duration flexibility can also attract customers who are uncertain about how long they will keep a base product, either because they are unsure about how much they will like it, or they are unsure about when a new product will appear on the market to tempt them to upgrade.

### BRIEF DESCRIPTION OF THE DRAWINGS

FIG. 1 is a flow chart illustrating an example of a method for making an extended warranty decision according to the present disclosure.

FIG. 2 is a flow chart illustrating another example of a method for making an extended warranty decision according to the present disclosure.

FIG. 3 illustrates a block diagram of an example of a machine-readable medium in communication with processing resources for making an extended warranty decision according to the present disclosure.

### DETAILED DESCRIPTION

Examples of the present disclosure may include methods, system's, and machine-readable and executable instructions and/or logic. An example method for making an extended warranty decision may include determining by a computer, a customer's expected cost of terminating the extended warranty coverage, determining, by the computer, the customer's expected cost of continuing the extended warranty coverage, and comparing, by the computer, the expected cost of terminating the extended warranty coverage and the expected cost of continuing the extended warranty coverage. An example method for making an extended warranty decision may also include determining, by the computer, the extended warranty coverage decision based on the comparison.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

A warranty is an assurance that some product or service will be provided or will meet certain specifications. Warranties can be utilized to assist in the management of customer relationships or as a mechanism to retain customers. An extended warranty may be a contract that can be purchased to cover the repair costs of product support or repair services beyond the warranty provider's original warranty period. An extended warranty may allow the customer to receive support and product repair services above and beyond what is provided by a base warranty associated with a product or hardware. An extended warranty may take the form of a flexible duration extended warranty or a fixed duration extended warranty.

A flexible duration extended warranty can be purchased by a customer at the time of a hardware purchase, with the option of canceling the warranty coverage at any time. A flexible duration extended warranty can also be adapted to warranties that can be purchased after the hardware purchase. This flexible duration extended warranty service can be billed up front, and the customer can receive a prorated refund if the customer cancels before the end of the warranty term. A flexible duration extended warranty service can also be billed on a periodic basis (e.g., monthly or quarterly).

A flexible duration extended warranty can increase an extended warranty attach rate, (e.g., the percentage of hardware units that are sold with an extended warranty) and may enable a warranty provider to charge a premium for the flexibility of the extended warranty. Customers may keep flexible duration extended warranty coverage for a shorter duration than fixed duration coverage (e.g., one year fixed duration extended warranty) because the customer has the freedom to cancel without penalty. In an example of customer behavior that adversely impacts a provider, customers may also cancel the flexible duration extended warranty coverage immediately after experiencing failure in the hardware. Some flexible duration extended warranties can include cancellation penalties.

When offering flexible or fixed duration extended warranty coverage to a customer, a warranty provider may seek to charge a premium that both entices customers and results in profit. For example, the provider may offer a flexible extended warranty with a premium (m) that is attractive to the customer because it can reduce expected support costs over the life of a product covered by the warranty.

A warranty provider may place restrictions on an extended warranty. For example, a flexible duration extended warranty can come with a restriction such that if a customer purchases coverage, the coverage must be started before the product reaches a pre-specified age. A flexible duration extended warranty can also come with a restriction such that the flexible extended warranty cannot be resumed once it is discontinued. A provider may impose such restrictions because it may not be feasible for the provider to verify that a customer's product is functional before allowing extended coverage. In some instances, a provider may require that extended coverage begins at the beginning of a planning horizon. A customer's planning horizon can begin at the end of a warranty originally provided with the product (e.g., a base warranty).

A customer may be uncertain about how long he or she will own the product (e.g., a holding horizon). The length of the customers holding horizon can depend on numerous factors including, but not limited to, product satisfaction, time before upgrade, and/or product reliability. Several variables can be considered when analyzing the uncertainty in the length of a customer's holding horizon. A probability (qᵢ(t)) that a customer will abandon the product in month t can be determined, where iε{0,1} denotes the product state with i=0 representing a failed product and i=1 representing a functioning product. The probability (q₀(t)) that a customer will abandon the product at the end of month t, given that the product is not functioning in month t can also be determined, as can the probability (q₁(t)) that a customer will abandon the product at the end of month t, given that the product is functioning in month t. In an example a fixed time horizon (T+1) model can be used as qᵢ(t)=0 for t=1, 2, . . . , T, i=0, 1, and qᵢ(T+1)=1 for i=0, 1, indicating that the product is abandoned at time T+1. This formulation can also allow for a random horizon that can be bounded above by T+1. In another example of a fixed horizon, q₀(t)=q₁(t)=0 for t=1, 2, . . . , T, Rₜ(pₜ)=(T+1−t)pₜc.

A failure indicator random variable (Iₜ) can also be considered in the analysis of a customer's uncertainty. The variable can take a value of 1 if there is a product failure in month t, and it can take a value of 0 otherwise. A failure history in months 1, 2, . . . t can be represented by Zₜ={I₁, I₂, . . . , Iₜ} and Z₀ can represent a prior belief about a failure process. In each month, a customer can update his or her estimate of the product failure probability based on the product's prior failure history. An estimated failure probability (pₜ₊₁(Zₜ)) at the beginning of month t+1 for failure history Zₜ can also be determined when analyzing holding horizon uncertainty.

Another variable that can be considered in analyzing holding horizon uncertainty and warranty coverage options is a product failure probability estimate at the beginning of month t+1. The failure probability estimate at the beginning of month t+1 when the month t failure probability estimate was pₜ, and a failure occurred in month t (pₜ₊₁⁺=Hₜ₊₁(pₜ,Iₜ=1)) can be determined. Furthermore, the failure probability estimate at the beginning of month t+1 when the month t failure probability estimate was pₜ and a failure did not occur in month t (pₜ₊₁⁻=Hₜ₊₁(pₜ,Iₜ=0)) can be determined, where Hₜ₊₁ is an updating function and pₜ₊₁(Iₜ) is a short notation: pₜ₊₁(Iₜ)=Hₜ₊₁(pₜ,Iₜ). For example, the estimated failure probability can be higher if a failure occurs in a current month.

The updating function Hₜ₊₁(pₜ,Iₜ) can be larger in any month when a failure occurred in a previous month. Furthermore, the updating function Hₜ₊₁(pₜ,Iₜ) can increase with respect to an estimated failure probability pₜ at the beginning of month t for all t and Iₜ, respectively. For example, the estimated failure probability in a given month can be increasing in the previous month's failure probability estimate.

A customer who has just purchased a new product may want to reduce a total expected cost (e.g., minimize a total expected cost) of supporting the product over a random planning horizon bounded by T+1. The customer may have to choose whether to begin coverage in the first month and continue or terminate warranty coverage for the product in each month thereafter. The customer can decide whether to continue coverage based on his or her estimate of the product failure probability variable. If a failure occurs and repairs occur immediately at the end of the same month, a repair cost (c) to the customer of an uncovered failure in month t can be a random variable Cₜ. An expected repair cost c=ECₜ can be independent of month t, and can be known to the customer and the warranty provider, where C represents a random variable, and EC represents an expected value.

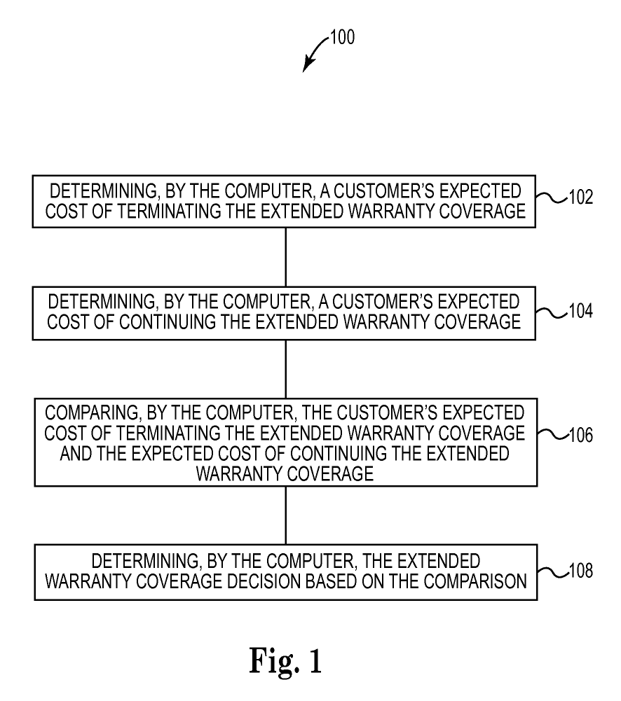

FIG. 1 is a flow chart illustrating an example of a method 100 for making an extended warranty decision according to the present disclosure. The method 100 can help determine a customer's coverage decision in a single period t. For example, a total coverage duration for an entire horizon may not be determined, but rather a decision can be made whether to continue or quit in period t for a given probability estimate pₜ. The effect and expected costs of terminating coverage in period t on periods t, . . . , T can be determined in period t, and those expected costs can be compared to expected costs incurred in periods t, . . . , T for continuing coverage in period t. A decision to continue or quite coverage can be based on the comparison (e.g., which cost is lower).

At 102, a customer's expected cost of terminating extended warranty coverage is determined. For example, a customer may consider whether there is a fee for terminating warranty coverage, or what it will cost him or her to fix or replace the product if it fails while not covered by warranty. The customer's minimum total expected cost of terminating coverage (Rₜ(pₜ)) during a time period or horizon {t, t+1, . . . T+1}, given that his or her estimated failure probability at the beginning of month t is pₜ, and he or she does not buy coverage in month t can be expressed as a function. For example, a customer's total expected cost of terminating coverage (Rₜ(pₜ)) at state (t, pₜ), t=1, 2, . . . T, can be

Rₜ(pₜ)=pₜ(1−q₀(t))(c+Rₜ₊₁(pₜ₊₁⁺))+(1−pₜ)(1−q₁(t))Rₜ₊₁(pₜ₊₁⁻).

It may be that customers don't repair failed products after a planning horizon, so the boundary conditions of the function can be R_{T+1}(•)=0, where “(•)” indicates that the argument can be any value, and R_{T+1}(•)=0 is equivalent to R_{T+1}(pₜ₊₁)=0 for any pₜ₊₁.

Updating schemes such as a Beta updating scheme and/or an exponential smoothing mechanism can be used in warranty coverage determinations, and can result in a sequence of random variables such that the conditional expected value of an observation at some time, given all the observations up to some earlier time, is equal to the observation at that earlier time (e.g., martingales).

Another variable that can be considered by warranty customers and providers is a customer's total expected cost (e.g., minimum total expected cost (Wₜ(pₜ)) during {t, t+1, . . . , T+1}, given that he or she had warranty coverage in month t−1 and that the product's estimated failure probability at the beginning of month t is pₜ, and that he or she buys coverage for month t. A customer's total expected cost (e.g., minimum total expected cost) during {t, t+1, . . . , T+1}, given that he or she had warranty coverage in month t−1, and that the product's estimated failure probability at the beginning of month t is pₜ can also be determined.

At 104, the customer's expected cost of continuing the extended warranty coverage can be determined. For example, a customer may consider continuing fees associated with the warranty, and whether the product is worth the coverage costs. A customer's expected cost (Bₜ(pₜ)) of continuing the warranty coverage in month t can be:

Bₜ(pₜ)=m+pₜ(1−q₀(t))Wₜ₊₁(pₜ₊₁⁺)(1−q₁(t)(Wₜ₊₁(pₜ₊₁⁻).

It may be desired to reduce the cost to the customer. For example, the action with the smallest cost can be:

Wₜ(pₜ)=min{Bₜ(pₜ,Rₜ(pₜ)}

with boundary conditions Wₜ₊₁(•)=0. For t=1, Wₜ(pₜ) can reflect a customer's choice of whether or not to start coverage. For t>1, Wₜ(pₜ) can reflect a customer's choice in each month between continuing warranty coverage and incurring total expected cost Bₜ(pₜ) or terminating coverage and incurring expected support costs Rₜ(pₜ) over the remainder of the horizon.

At 106, the expected cost of terminating the extended warranty coverage (Rₜ(pₜ)) and the expected cost of continuing the extended warranty coverage (Bₜ(pₜ) are compared. Rₜ(pₜ)−Bₜ(pₜ) can be the total benefit of continuing a flexible (e.g., monthly) extended warranty in month t, given that the estimated failure probability is pₜ. The total benefit of continuing a monthly warranty may increase in estimated failure probability pₜ as months progress. For example, if the probability that a customer will abandon a product at the end of month t given the product fails is increasing in t (e.g., q₀(1)≦q₀(2)≦ . . . ≦q₀(T)), then Rₜ(pₜ)−Bₜ(pₜ) can be increasing in pₜ for t=1, 2, . . . T. Furthermore, Rₜ(pₜ)−Bₜ(pₜ) can be less than or equal to

$$\frac{( 1 - {q}_{0} ( t ) ) c - m}{{q}_{0} ( t )}$$

if q₀(t)>0.

At 108, the extended warranty coverage decision is determined (e.g., the decision is made) based on the comparison of the expected cost of terminating the extended warranty coverage and the expected cost of continuing the extended warranty coverage. A customer can determine if he or she wants to continue coverage (if he or she was covered in the previous month) in month t by determining if Rₜ(pₜ)−Bₜ(pₜ)≧0. For example, the customer may determine he or she will continue coverage (e.g., it is optimal to continue coverage) if Rₜ(pₜ)−Bₜ(pₜ)>0, but he or she will choose not to continue coverage if Rₜ(pₜ)−Bₜ(pₜ)<0. If Rₜ(pₜ)−Bₜ(pₜ)=0, the customer may be indifferent between buying coverage and stopping coverage.

A customer can also choose to continue coverage in month t if a failure probability at the beginning of month t (e.g., pₜ) is greater than or equal to a certain threshold (pₜ*). For example, if q₀(t) is increasing in t, then there can exist a sequence {pₜ*: t=1, . . . , T} such that a customer chooses to continue coverage (e.g., it is optimal to continue coverage) in month t if and only if the estimated failure probability pₜ≧pₜ*. Moreover, in an example,

$${p}_{t}^{*} \leq \frac{m}{( 1 - {q}_{0} ( t ) ) c} .$$

Similarly, a customer's coverage policy (e.g., optimal coverage policy) can have a threshold structure with a change in a condition under which the threshold policy structure holds. For example, if q₀(t)≦q₁(t) for t=1, 2, . . . , T−1, there can be a threshold pₜ* in month t such that a customer continues (e.g., it is optimal to continue) coverage in month t if and only if pₜ≧pₜ*.

These warranty coverage duration determinations and/or thresholds can be independent of a failure realization, so they can be pre-computed. A customer's determination may change if his or her extended warranty allows for the customer to begin coverage at any time in a product's life or if the customer can resume coverage after discontinuing it. For example, a customer can decide to buy coverage in month t if

$${p}_{t} \geq \frac{m}{1 - {q}_{0} ( t ) ) ( c )} .$$

A customer with a more restrictive flexible duration extended warranty who bought coverage in a previous month may be more likely to buy coverage in the current month than a customer of a less restrictive flexible duration extended warranty because

$${p}_{t}^{*} \leq \frac{m}{( 1 - {q}_{0} ( t ) ) c}$$

for all t,

A customer may be less likely to purchase a flexible duration monthly extended warranty as the price of the warranty increases. A customer may be more likely to purchase a flexible duration monthly extended warranty as the price of the repair cost to the customer increases. For example, thresholds (e.g., optimal thresholds) can increase regarding a monthly premium m for all t=1, 2, . . . , T. Similarly, the thresholds can decrease regarding cost t=1, 2, . . . , T.

In some instances, a policy may not have a threshold structure, rather a customer can decide whether to buy warranty coverage based on failure estimates. For example, for decreased failure probability estimates, a customer may not buy coverage because he or she is less likely to experience a failure, whereas for an increased failure probability estimate, he or she may not buy coverage because he or she is more likely to abandon the product, so his or her monthly premium would be wasted. For a moderate failure probability estimate, the customer may purchase coverage. Product abandonment probabilities can also depend on coverage status. For example, a customer may be more likely to abandon a failed product if the product is not covered by a warranty.

A customer can choose to continue warranty coverage based on the likelihood a product will fail, and a customer can periodically update the likelihood of failure. For example, an older product may be more likely to fail than a brand new product. In an example of a failure probability updating scheme, a customer can have a prior β(a,b), corresponding to the Beta distribution with parameters a and b, that he or she updates after each month as follows. Let a₁=a and b₁=b. Given aₜ and bₜ at the beginning of month t, then aₜ₊₁=a+Iₜ and bₜ₊₁=bₜ+(1−Iₜ). As a result, at the beginning of month t+1, the expected failure probability can be:

pₜ₊₁=aₜ₊₁/(aₜ₊₁+bₜ₊₁).

The expected failure probability in month t+1 can be:

pₜ₊₁⁺=(aₜ+1)/(aₜ₊₁+bₜ₊₁) if a failure occurs in month t, and

pₜ₊₁⁻=aₜ/(aₜ+bₜ₊₁) if no failure occurs in month t.

The updating scheme can be nonstationary. For example, an estimate pₜ(•) can depend on t, and pₜ(•) can be different from pₜ₊₁(•).

A customer can dynamically apply a coverage policy (e.g., and optimal coverage policy) to lower (e.g., minimize) his or her total expected cost, based on failure observations. The customer can also consider dynamic reliability learning (e.g., Beta updating scheme and/or exponential smoothing mechanism) and uncertainty in product replacement time (e.g., as considered through abandon probabilities qᵢ(t)) when determining warranty coverage duration. A customer can use a Beta updating scheme to update failure probabilities. For example, if a policy (e.g., an optimal policy) has a threshold structure with thresholds pₜ*, then there can exist a sequence of {xₜ*: t=1, 2, . . . , T} for a Beta updating scheme such that a customer continues coverage (e.g., it is optimal for a customer to continue coverage) in month t if and only if Nₜ≧xₜ*, where Nₜ is a total number of observed failures prior to month t.

A failure probability updating scheme can be stationary, and it can be independent of month t. For example, pₜ₊₁(Z) can equal H(pₜIₜ), where H(•,•) is an updating function, independent of t. Furthermore, in some instances a benefit of buying coverage, which corresponds to Rₜ(pₜ)−Bₜ(pₜ), can be lower as a customer nears the end of a horizon. For example, if both q₀(t) and q₁(t) are increasing in time t (e.g., q₀(1)≦q₀(2)≦ . . . ≦q₀(T) and q₁(1)≦q₁(2)≦ . . . ≦q₁(T)), then Rₜ(p), Bₜ(p), and Wₜ(p) can all be decreasing in t, for 0≦p≦1. Furthermore, Rₜ(p)−Bₜ(p) can be decreasing in t for 0≦p≦1.

In some instances, a customer's likelihood of continuing flexible duration (e.g., monthly) extended warranty coverage can decrease as the end of the horizon gets closer. For example, if both q₀(t) and q₁(t) are increasing in time t, a threshold for a customer policy (e.g., a threshold in a customer's optimal coverage policy) can increase in time, such that p₁*≦p₂*≦ . . . ≦p_{T}*.

Although the thresholds may be increasing, each month's threshold can be bounded above by an estimated failure probability based on the threshold in the previous month. If a customer is to buy coverage (e.g., it is optimal for a customer to buy coverage) in month t, and a failure occurs in month t, then he or she may buy coverage (e.g., it may be optimal for him or her to buy coverage) in month t+1 as well because his or her updated failure probability estimate may exceed a threshold pₜ₊₁* in month t+1. The customer may keep the warranty after a covered failure unless the failure occurs during the last month T of the horizon. For example, if q₀(t) is constant, q₁(t) is increasing in t and for all 0≦pₜ≦1, then pₜ₊₁*≦pₜ₊₁*⁺.

An example of a stationary failure probability updating scheme is an exponential smoothing mechanism. An assumption can be made that a prior failure probability estimate is p₁, and a customer updates the estimate as follows:

pₜ₊₁=pₜ+α(Iₜ=pₜ) for t=1, 2, . . . , T−1,

where α is constant and 0≦α≦1. The parameter α can reflect a degree of inertia in the failure probability estimate. For example, lower values of a can correspond to increased inertia. A probability estimate in the next month can depend on a current probability estimate and a failure observation in a current month. The customer can compare a failure observation with an estimated failure probability and make a linear adjustment, so the exponential smoothing mechanism can also be called linear adjustment scheme. If a failure occurs in month t, then pₜ₊₁*=(1−α)pₜ+α. If a failure does not occur in month t, then pₜ₊₁⁻=(1−α)pₜ. Using the aforementioned updated estimate pₜ₊₁ can be:

pₜ₊₁=(1−α)^{t}p₁+Σᵢ₌₀^{t-1}α(1−α)^{t}Iₜ₋₁.

In a Beta updating scheme, the estimate of the failure probability in the next month can depend on the number of observed failures up to the current month, with each failure having the same weight, or importance. In the exponential smoothing mechanism, a more recent failure carries a higher importance, or weight, than an older failure.

A customer can make a decision regarding a flexible duration extended warranty based on a probability estimate and an adjustment factor. For example, a customer may be more likely to buy a flexible duration extended warranty in a first month, for any given prior probability estimate, if the adjustment factor is higher. For example, if q₀(t)=q₁(t) for t=1, 2, . . . , T, then both Bₜ(pₜ) and Wₜ(pₜ) can be increasing concave in pₜ, respectively, for t=1, 2, . . . , T. If q₀(t)=q₁(t) for t=1, 2, . . . , T, then both Bₜ(pₜ) and Wₜ(pₜ) can be decreasing concave in α, respectively, for 0≦pₜ≦1 and t=1, 2, . . . , T. If q₀(t)=q₁(t) for t=1, 2, . . . , T, then thresholds pᵢ* can be decreasing in α for t=1, 2, . . . , T.

A warranty provider may be concerned about profits, and specifically, what the warranty provider's profit can be on a customer-by-customer basis. A provider can determine a customer's total expected purchase duration, as well as the provider's expected profit per customer.

The repair cost to the provider (βC) for a failure with cost C to the customer, where β is constant and 0≦β≦1 can be determined, provided, or it may be known. Product abandonment probabilities from month t to the end of the horizon can be denoted as Qₜ:={(q₀(i), q₁(i): i=t, t+1, . . . T}, and πₜ(pₜ, m, Qₜ) and Dₜ(pₜ,m,Qₜ) can represent the total expected profit to the provider and the customer's total expected purchase duration, respectively, from month t to the end of the horizon, given that the customer's estimated failure probability at the beginning of the month t is pₜ, the monthly warranty premium is m, and the product abandonment probabilities are Qₜ.

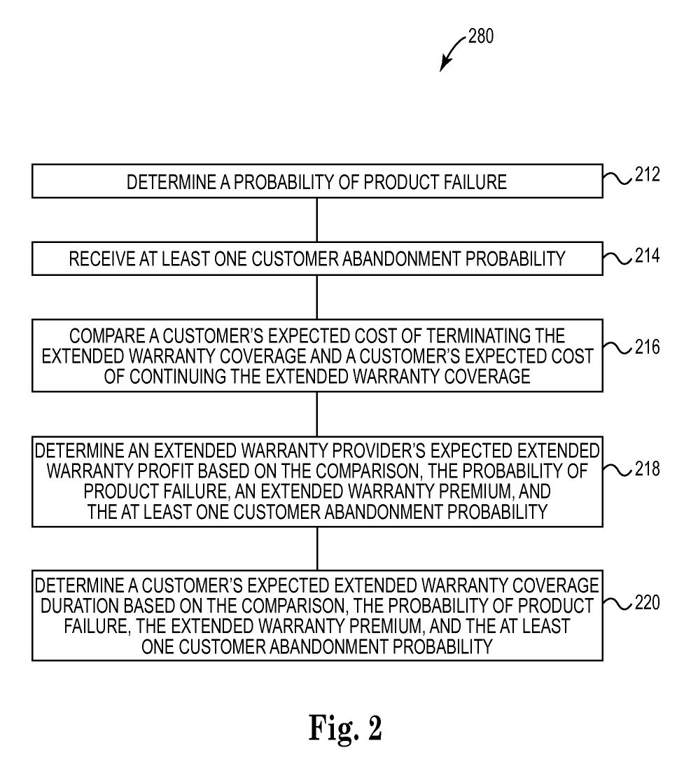

FIG. 2 is a flow chart illustrating another example of a method 280 for making an extended warranty coverage decision according to the present disclosure. At 212, a probability of product failure is determined. This probability can be determined using a prior product failure probability and updates to the prior product failure probability according to a product failure history. For example, the probability is an input in period 1 (e.g., t=1), and if it's a later period (e.g., t>1), then the probability estimate can be determined by updating a previous probability estimate according to a customer's updating scheme. At least one customer abandonment probability is received at 214, and a customer's expected cost of terminating the extended warranty coverage and a customer's expected cost of continuing the extended warranty coverage are compared at 216. At 218, a warranty provider's expected extended warranty profit (πₜ) based on the comparison, the probability of product failure, an extended warranty premium, and the customer abandonment probability is determined. At 220, a customer's expected extended warranty coverage duration (Dₜ) is determined based on the comparison, the probability of product failure, the extended warranty premium, and the at least one customer abandonment probability.

A provider can have a repair cost βC for a failure with cost C to the customer, where β is constant and 0≦β<1, and abandonment probabilities from month t to the end of a horizon can be Qₜ={(q₀(i), q₁(i)): i=t, t+1, . . . , T}. A total expected profit to a provider can be πₜ(pₜ, m, Qₜ), and a customer's total expected purchase duration can be Dₜ(pₜ, m, Qₜ), from month t to the end of the horizon, given that the customer's estimated failure probability at the beginning of month t is pₜ, the monthly premium is m, and the abandonment probabilities are Qₜ.

At 220 the expected cost of terminating the warranty coverage and the expected cost of continuing the warranty coverage are compared, and the customer's warranty coverage duration can be determined at 222 based on the comparison, the expected warranty profit, and the expected warranty purchase duration. For example, if Rₜ(pₜ)−Bₜ(pₜ)≧0, then the customer may choose to continue to buy a flexible duration extended warranty in month t (e.g., it is optimal to continue), and

πₜ(pₜ,m,Qₜ)=m+λ(1−q₀(t))(πₜ₊₁(pₜ₊₁⁺,m,Qₜ₊₁)−βc)+(1−λ)(1−q₁(t))πₜ₊₁(pₜ₊₁⁻,m,Qₜ₊₁), and

Dₜ(pₜ,m,Qₜ)=1+λ(1−q₀(t))Dₜ₊₁(pₜ₊₁⁺,m,Qₜ₊₁)+(1−λ)(1−q₁(t))Dₜ₊₁(pₜ₊₁⁻,m,Qₜ₊₁).

If Rₜ(pₜ)−Bₜ(pₜ)<0, then the customer will choose not to continue to buy a flexible duration extended warranty in month t (e.g., it is not optimal to continue) and πₜ(pₜ, m, Qₜ)=0 and Dₜ(pₜ, m, Qₜ)=0. Boundary conditions can be π_{T+1}(•,•,•)=0 and D_{T+1}(•,•,•)=0. Then, a total profit from a customer can be πₜ(pₜ, m, Qₜ), and a customer's total expected purchase duration can be Dₜ(pₜ, m, Qₜ), where p₁ is a prior failure probability estimate and Q₁ can represent the abandonment probabilities from month 1 to the end of the horizon.

A warranty provider can decide whether he or she would like to provide a flexible extended warranty (e.g., monthly) or a fixed extended warranty based on the market of people who purchase the warranties. The market can take many forms. For example, the market can be heterogeneous or homogeneous, among others. A heterogeneous market can include a mix of different types of customers. For example, it can include customers of type “L” and customers of type “H.” Type L customers believe that the product is less likely to fail in a given period than do type H customers. For example, type L customer's prior failure probability estimate is lower than that of the type H customers. Because of these beliefs, type H customers may be more likely to purchase an extended warranty (e.g., fixed or flexible) to protect themselves against failure, whereas type L customers may be less likely to purchase an extended warranty of any kind. In a homogeneous market, the market consists of only one type of customer. For example, the market may consist of only type L customers or only type H customers. By determining the type of customers that exist in a provider's customer base, the provider can better determine which type of extended warranty to offer, or if he or she should offer a menu of extended warranties.

In a homogeneous market, a monthly warranty provider can determine a cost of a monthly warranty premium m. For example, the provider can chose an optimal monthly premium m*=argmax_{m≧0}π₁(p₁, m, Q₁) and an optimal profit π₁(p₁, m*, Q₁). A fixed duration extended warranty of duration T months can have a total expected support cost Sₜ(Qₜ) to the provider for a customer from month t to the end of the horizon, given that the customer's abandonment probabilities are Qₜ. In such a case, Sₜ can be:

S₁(Q₁)=λ(1−q₀(t))(βc+Sₜ₊₁(Qₜ₊₁))+(1−λ)(1−q₁(t))Sₜ₊₁)(Qₜ₊₁),

with boundary conditions S_{T+1}(•)=0.

In a market where only a fixed duration extended warranty or pay-as-you-go repair service is available, and all customers are homogeneous, a customer may make a decision to purchase a fixed duration extended warranty based on price and abandonment probabilities. For example, a customer may choose to only purchase the fixed duration extended warranty if its price (r) is not greater than the cost of not purchasing warranty R₁(p₁) with abandonment probabilities Q₁. A fixed duration extended warranty provider can choose a warranty price (r) to reach an expected profit (e.g., to maximize his or her total expected profit and/or reach a highest overall total expected profit threshold). The expected profit can be:

max_{r≧0}{π^{t}(p₁,r,Q₁):=(r−S₁(Q₁))1(r≦R₁(p₁))},

where indicator function 1(z)=1 if z is true; 1(z)=0 otherwise. A price and profit for the fixed duration extended warranty can be determined. For example, an optimal price of the fixed duration extended warranty can be:

arg max_{r≧0}π^{t}(p₁,r,Q₁),

and an optimal profit of the fixed duration extended warranty can be:

π^{t}(p₁,r,Q₁).

In a homogeneous market where customers follow an updating scheme (e.g., Beta updating scheme and/or exponential smoothing mechanism), and q₀(t)=q₁(t) for t=1, 2, . . . , T, a monthly warranty can be more profitable to the provider than a fixed duration extended warranty if the prior failure probability p₁ satisfies p₁<p₁⁰, where

p₁⁰=inf{p₁≧0:π₁(p₁,m*,Q₁)≦R₁(p₁)−S₁(Q₁)}.

In a homogeneous market where customers have a decreased prior failure probability estimate, then a customer's willingness to pay for a fixed duration extended warranty can decrease, and a fixed duration extended warranty can result in decreased profits. Because of this, a monthly warranty can be more profitable under these homogenous market circumstances.

In a heterogeneous market, a provider may have to choose a monthly premium m to increase (e.g., maximize) his total expected profit over all market segments. For example, if a heterogeneous market has N market segments, and market segment n has a prior failure probability estimate p₁⁽ⁿ⁾, abandonment probabilities Q₁⁽ⁿ⁾:={q₀⁽ⁿ⁾(i),q₁⁽ⁿ⁾(i): i=1, 2, . . . , T}, and proportion λₙ. The total market size can be normalized to be 1 (e.g., Σₙ₌₁^{N}λₙ=1). The provider's total expected profit from a monthly premium m (e.g., maximum total expected profit) over all market segments can be:

max_{m≧0}{Σₙ₌₁^{N}λₙπ₁(p₁⁽ⁿ⁾,m,Q₁⁽ⁿ⁾)}.

In a market where only fixed duration extended warranties or pay-as-you-go services are available, a customer of market segment n may buy a fixed duration extended warranty if its price r is not greater than the cost of not purchasing warranty R₁⁽ⁿ⁾(p₁⁽ⁿ⁾) with abandonment probabilities Q₁⁽ⁿ⁾. The provider's total expected profit from a fixed duration extended warranty of price r (e.g., maximum total expected profit) over all market segments can be:

max_{r≧0}{Σₙ₌₁^{N}λₙ(r−S₁⁽ⁿ⁾)1(r≦R₁⁽ⁿ⁾(p₁⁽ⁿ⁾))}.

When a provider offers a menu of monthly warranty and fixed duration extended warranty options, the customer can select the one with the lower cost. The provider's total expected profit from a monthly warranty premium m and a fixed duration extended warranty of price r (e.g., maximum total expected profit of monthly and fixed duration) over all market segments can be

max_{m≧0,r≧0}{Σₙ₌₁^{N}λₙ(π₁(p₁⁽ⁿ⁾,m,Q₁⁽ⁿ⁾)1(W⁽ⁿ⁾(p₁⁽ⁿ⁾)≦r)+(r−S₁⁽ⁿ⁾)1(r≦W₁⁽ⁿ⁾(p₁⁽ⁿ⁾)))},

where W₁⁽ⁿ⁾(p₁⁽ⁿ⁾) is a cost (e.g., minimum cost) of the monthly warranty to a customer in market segment n.

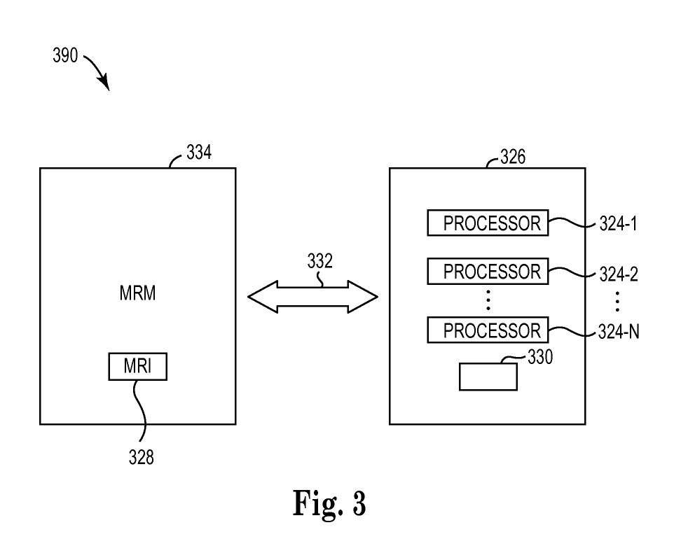

FIG. 3 illustrates a block diagram 390 of an example of a machine-readable medium (MRM) 334 in communication with processing resources 324-1, 324-2 . . . 324-N for determining warranty coverage according to the present disclosure. MRM 334 can be in communication with a computing device 326 (e.g., Java application server, having processor resources of more or fewer than 324-1, 324-2 . . . 324-N). The computing device 326 can be in communication with, and/or receive a tangible non-transitory MRM 334 storing a set of machine readable instructions 328 executable by one or more of the processor resources 324-1, 324-2 . . . 324-N, as described herein. The computing device 326 may include memory resources 330, and the processor resources 324-1, 324-2 . . . 324-N may be coupled to the memory resources 330.

Processor resources 324-1, 324-2 . . . 324-N can execute machine-readable instructions 328 that are stored on an internal or external non-transitory MRM 334. A non-transitory MRM (e.g., MRM 334), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), flash memory, etc., as well as other types of machine-readable media.

The non-transitory MRM 334 can be integral, or communicatively coupled, to a computing device, in either in a wired or wireless manner. For example, the non-transitory machine-readable medium can be an internal memory, a portable memory, a portable disk, or a memory associated with another computing resource (e.g., enabling the machine-readable instructions to be transferred and/or executed across a network such as the Internet).

The MRM 334 can be in communication with the processor resources 324-1, 324-2 . . . 324-N via a communication path 332. The communication path 332 can be local or remote to a machine associated with the processor resources 324-1, 324-2 . . . 324-N. Examples of a local communication path 332 can include an electronic bus internal to a machine such as a computer where the MRM 334 is one of volatile, non-volatile, fixed, and/or removable storage medium in communication with the processor resources 324-1, 324-2 . . . 324-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 332 can be such that the MRM 334 is remote from the processor resources e.g., 324-1, 324-2 . . . 324-N such as in the example of a network connection between the MRM 334 and the processor resources e.g., 324-1, 324-2 . . . 324-N. That is, the communication path 332 can be a network connection. Examples of such a network connection can include a local area network (LAN), a wide area network (WAN), a personal area network (PAN), and the Internet, among others. In such examples, the MRM 334 may be associated with a first computing device and the processor resources 324-1, 324-2 . . . 324-N may be associated with a second computing device (e.g., a Java application server).

The processor resources 324-1, 324-2 . . . 324-N coupled to the memory 330 can determine an extended warranty market type and determine a probability of product failure for a segment of the market type. The processor resources 324-1, 324-2 . . . 324-N coupled to the memory 330 can also determine at least one customer abandonment probability for the segment and determine a proportion of the extended warranty market that the segment represents. Furthermore, the processor resources 324-1, 324-2 . . . 324-N coupled to the memory 330 can determine an extended warranty premium based on the market type, the probability of product failure, the at least one customer abandonment probability, and the proportion.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A computer-implemented method for making an extended warranty coverage decision comprising:
determining, by the computer, a customer's expected cost of terminating the extended warranty coverage;
determining, by the computer, the customer's expected cost of continuing the extended warranty coverage;
comparing, by the computer, the expected cost of terminating the extended warranty coverage and the expected cost of continuing the extended warranty coverage; and
determining, by the computer, the extended warranty coverage decision based on the comparison.

2. The method of claim 1, wherein the extended warranty coverage decision is determined for a single time period.

3. The method of claim 1, further comprising determining a prior product failure probability for the product covered by the extended warranty and performing a Beta updating scheme to update the prior product failure probability based on actual product failures experienced.

4. The method of claim 1, further comprising determining a prior product failure probability for the product covered by the extended warranty and using an exponential smoothing mechanism to update the prior product failure probability.

5. The method of claim 1, wherein determining the extended warranty coverage decision is further based on a comparison of a product failure probability to a predetermined product failure threshold.

6. The method of claim 1, further comprising determining the customer's expected cost of terminating the extended warranty coverage as a function of:
a product failure probability;
a product abandonment probability; and
an expected repair cost.

7. The method of claim 1, further comprising determining the customer's expected cost of continuing the extended warranty coverage as a function of:
a product failure probability;
an extended warranty premium;
an expected repair cost; and
a product abandonment probability.

8. A non-transitory machine-readable medium storing a set of instructions for making an extended warranty coverage decision executable by a computer to cause the computer to:
determine a probability of product failure;
receive at least one customer abandonment probability;
compare a customer's expected cost of terminating the extended warranty coverage and a customer's expected cost of continuing the extended warranty coverage;
determine an extended warranty provider's expected extended warranty profit based on the comparison, the probability of product failure, an extended warranty premium, and the at least one customer abandonment probability; and
determine a customer's expected extended warranty coverage duration based on the comparison, the probability of product failure, the extended warranty premium, and the at least one customer abandonment probability.

9. The medium of claim 8, wherein the extended warranty coverage includes flexible duration extended warranty coverage.

10. The medium of claim 8, wherein the instructions are executable by the computer to cause the computer to determine the probability of product failure using a prior product failure probability and updates to the prior product failure probability according to a product failure history.

11. A computing system for making an extended warranty coverage decision comprising:
a memory;
a processor resource coupled to the memory, to:
determine an extended warranty market type;
determine a probability of product failure for a segment of the market type;
determine at least one customer abandonment probabilities for the segment;
determine a proportion of the extended warranty market that the segment represents; and
determine an extended warranty premium based on the market type, the probability of product failure, the at least one customer abandonment probability, and the proportion.

12. The system of claim 11, wherein the processor coupled to the memory determines the extended warranty premium further based on reaching a total expected profit improvement threshold.

13. The system of claim 11, wherein the processor couple to the memory determines the probability of product failure using a prior product failure probability and updates to the prior product failure probability according to a product failure history.

14. The system of claim 11, wherein the market type is homogenous.

15. The system of claim 11, wherein the market type is heterogeneous.
